(19) United States
(12) Patent Application Publication
(10) Pub. No.: US 2007/0128010 A1
(43) Pub. Date: Jun. 7, 2007

(54) AN APPARATUS FOR POD TRANSPORTATION WITHIN A SEMICONDUCTOR FABRICATION FACILITY

(75) Inventors: Jeffrey P. Gifford, Fishkill, NY (US); David J. Pinckney, Newtown, CT (US); Benjamin R. Wheeler, Mount Kisco, NY (US); Uldis A. Ziemins, Poughkeepsie, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, ARMONK, NY (US)

(21) Appl. No.: 11/164,793

(22) Filed: Dec. 6, 2005

(51) Int. Cl. B65G 47/90; B65G 1/00

(52) U.S. Cl. 414/281; 414/626; 414/277

(57) ABSTRACT

The invention is directed to an improved apparatus and method for transportation of a pod in a semiconductor fabrication facility. The invention comprises a lead vehicle with a communication system and control system and a trailer with a mechanism for delivering and receiving pods from stations in the facility. The trailer is connected to the lead vehicle and has a compartment for the transportation of a pod, but comprises fewer components than the lead vehicle. Therefore, the invention is manufactured at reduced cost, but with double pod transportation capacity.

### BACKGROUND OF THE INVENTION

1. Field of the Invention

The invention relates generally to semiconductor manufacturing, and more particularly to an improved apparatus for pod transportation within a semiconductor fabrication facility.

2. Description of the Related Art

Reduction of semiconductor processing cycle time is of utmost importance within a semiconductor fabrication facility. Transportation moves within a semiconductor fabrication facility increase semiconductor processing cycle time. Therefore, it has become increasingly important to reduce transportation moves within a semiconductor fabrication facility.

The prior art apparatus for transportation of pods through the semiconductor fabrication facility were costly and inefficient. More specifically, prior art apparatuses for transportation of pods through the semiconductor fabrication facility included a multitude of features, often unnecessary for the transportation of pods. For example, each prior art apparatus included a control system, a communication system, and a mechanism for delivering an receiving pods from stations in the semiconductor fabrication facility. In addition, each prior art apparatus could only transport one pod at a time.

The prior art apparatus is problematic because the manufacturing cost of prior art apparatuses is high, and yet the ability of the prior art apparatus to efficiently deliver pods is low because the prior art apparatus can only hold one pod at a time.

What is needed in the art is an improved apparatus for pod transportation that is cost effective and efficient.

### BRIEF SUMMARY OF THE INVENTION

The invention is an apparatus and method for pod transportation with a semiconductor fabrication facility.

The apparatus of the invention comprises a trailer and a lead vehicle. The trailer comprises a compartment for storing a pod and a mechanism for delivering from the compartment a pod to a station in the semiconductor facility or receiving a pod from a station in the semiconductor facility into the compartment. The lead vehicle comprises a communication system and a control system. The communication system receives an instruction from a material control system (MCS) that is either (1) delivery of a pod from the compartment of the trailer to one of the stations in the semiconductor fabrication facility or (2) receipt of a pod from one of the stations in the semiconductor fabrication facility into the compartment in said trailer. The control system coordinates transportation of said trailer to the stations in the semiconductor fabrication facility described in the instruction and causes the mechanism of the trailer to either deliver in response to receipt of a delivery instruction from the MCS or receive In response to receipt of a receive instruction from said MCS.

The method of the invention comprises a receiving, transporting, and causing step. The receiving step comprises receiving an instruction of either (1) delivery of a pod from a compartment in a trailer attached to a lead vehicle to a station in the semiconductor fabrication facility and (2) receipt of the pod from one station in the semiconductor fabrication facility into the compartment of the trailer. The transporting step comprises transporting the trailer to a station in the semiconductor fabrication facility described in the instruction. The causing step comprises causing the trailer to deliver a pod to the station in response to receipt of a delivery instruction or receive a pod in response to receipt of a receive instruction.

The invention is directed to an improved apparatus and method for pod transportation within a semiconductor fabrication facility. The invention reduces vehicle transportation time within a semiconductor fabrication facility. Therefore, the invention reduces semiconductor processing cycle time.

For at least the foregoing reasons, the invention improves upon pod transportation within a semiconductor fabrication facility.

### BRIEF DESCRIPTION OF THE DRAWINGS

The features and the element characteristics of the invention are set forth with particularity in the appended claims. The figures are for illustrative purposes only and are not drawn to scale. Furthermore, like numbers represent like features in the drawings. The invention itself, however, both as to organization and method of operation, may best be understood by reference to the detailed description which follows, taken in conjunction with the accompanying figures, in which:

FIG. 1 depicts an apparatus in accordance with the invention.

### DETAILED DESCRIPTION OF THE INVENTION

The invention will now be described with reference to the accompanying figures. In the figures, various aspects of the structures have been depicted and schematically represented in a simplified manner to more clearly describe and illustrate the invention.

By way of overview and introduction, the invention is directed to an apparatus and method for pod transportation within a semiconductor fabrication facility. More specifically, the invention comprises an apparatus with a lead vehicle that comprises a control system, a communication system, and a mechanism for delivering an receiving pods from stations in the semiconductor fabrication facility and a trailer that comprises the a mechanism for delivering and receiving pods from stations in the semiconductor fabrication facility and a trailer. The trailer is connected to the lead vehicle with a tow bar. Because the trailer does not include as many features as the lead vehicle, the trailer is less costly to manufacture. In addition, because the apparatus of the invention can transport at least two pods, the apparatus doubles the efficiency of prior art apparatus. Therefore, the apparatus of the invention reduces semiconductor manufacturing cycle time.

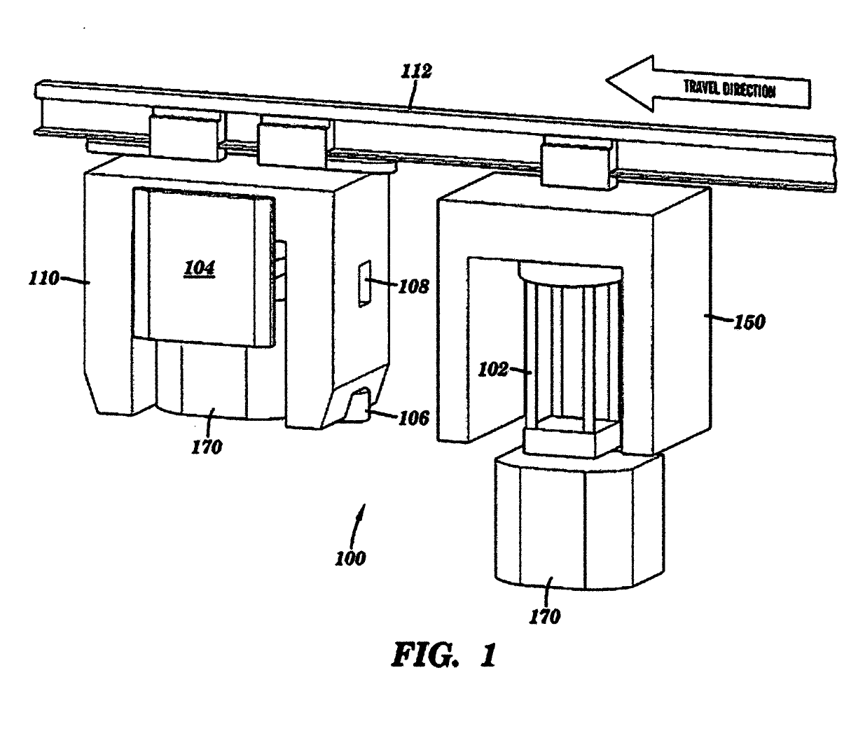

FIG. 1 depicts an apparatus in accordance with the invention 100. The apparatus of the invention 100 comprises a lead vehicle 110 and a trailer 150. The lead vehicle 110 includes a communication system 104, control system 106, sensors 108, as well as a mechanism for delivering and receiving (not shown) pods 170 from station in the semiconductor fabrication facility. The trailer 150 comprises fewer components than the lead vehicle 110. The only feature that the trailer 150 must comprise is a mechanism for delivering and receiving 102 pods 170 from station in the semiconductor fabrication facility. Pods 170 include both reticle storage pods (RSP) and front opening unified pods (FOUP). As depicted a tow bar 112 connects the lead vehicle 110 to the trailer 150.

The communication system 104 of the lead vehicle 110 receives instructions from a material control system (not shown) regarding the receipt and delivery of pods 170 for both the lead vehicle 110 and the trailer 150. The lead vehicle 110 further comprises the motor (not shown) that powers the transportation of both the lead vehicle 110 and trailer 150 throughout the semiconductor fabrication facility. The instruction received from the MCS comprises any iteration of receipt or delivery of a pod 170 into or from a process tool or storage container for either compartment of the lead vehicle 110, the trailer 150, or both.

While the invention has been particularly described in conjunction with a specific preferred embodiment and other alternative embodiments, it is evident that numerous alternatives, modifications and variations will be apparent to those skilled in the art in light of the foregoing description. It is therefore intended that the appended claims embrace all such alternatives, modifications and variations as falling within the true scope and spirit of the invention.

What is claimed is:

1. An apparatus for pod transportation within a semiconductor fabrication facility, comprising:
a trailer with a compartment for storing a pod and a mechanism for delivering from said compartment said pod to one of a plurality of stations in said semiconductor fabrication facility and for receiving said pod from one of a plurality of stations in said semiconductor fabrication facility into said compartment; and,
a lead vehicle connected to said trailer with a communication system that receives an instruction from a material control system (MCS) comprising one of delivery of said pod from said compartment in said trailer to one of a plurality of stations in said semiconductor fabrication facility and receipt of said pod from one of a plurality of stations in said semiconductor fabrication facility into said compartment in said trailer; and, a control system that coordinates transportation of said trailer to said one of a plurality of stations in said semiconductor fabrication facility described in said instruction and causes said mechanism of said trailer to deliver in response to receipt of a delivery instruction from the MCS and causes said mechanism of said trailer to receive in response to receipt of a receive instruction from said MCS.

2. An apparatus as in claim 1, said pod comprises one of a reticle storage pod (RSP) and front opening unified pod (FOUP).

3. An apparatus as in claim 1, said lead vehicle with a compartment for storing said pod and a mechanism for delivering from said compartment said pod to one of a plurality of stations in a semiconductor fabrication facility and for receiving said pod from one of a plurality of stations in said semiconductor fabrication facility into said compartment.

4. An apparatus as In claim 3, said instruction further comprising one of delivery of said pod from said compartment in said lead vehicle to one of a plurality of stations in said semiconductor fabrication facility and receipt of said pod from one of a plurality of stations in said semiconductor fabrication facility into said compartment of said lead vehicle.

5. An apparatus as in claim 4, a station in said plurality comprising one of a semiconductor process tool and a storage container.

6. An apparatus as in claim 5, said instruction comprising receipt of a first pod into an empty compartment of one of said lead vehicle and trailer from said one of a semiconductor process tool and storage container and delivery of a second pod to one of a semiconductor process tool and storage container from another compartment of said one of said lead vehicle and trailer.

7. An apparatus as in claim 6, said second pod delivered to same one of a semiconductor process tool and storage container from which said first pod was received.

8. An apparatus as in claim 6, said second pod delivered to different one of a semiconductor process tool and storage container from which said first pod was received.

9. An apparatus as in claim 5, said instruction comprising receipt of a first pod into an empty compartment of a first one of said lead vehicle and trailer from said one of a semiconductor process tool and storage container and receipt of a second pod into an empty compartment of a second one of said lead vehicle and trailer from said one of a semiconductor process tool and storage container.

10. An apparatus as in claim 9, said second pod received from same one of a semiconductor process tool and storage container from which said first pod was received.

11. An apparatus as in claim 9, said second pod received from different one of a semiconductor process tool and storage container from which said first pod was received.

12. An apparatus as in claim 5, said instruction comprising delivery of a first pod from said compartment of a first one of said lead vehicle and trailer from said one of a semiconductor process tool and storage container and delivery of a second pod from said compartment of a second one of said lead vehicle and trailer from said one of a semiconductor process tool and storage container.

13. An apparatus as in claim 12, said second pod delivered to said same one of a semiconductor process tool and storage container from which said first pod was delivered.

14. An apparatus as in claim 9, said second pod delivered to different one of a semiconductor process tool and storage container from which said first pod was delivered.

15. An apparatus as in claim 1, said lead vehicle connected to said trailer with a tow bar.

16. An apparatus as in claim 1, said lead vehicle further comprising a motor that powers transportation of both said lead vehicle and said trailer through said semiconductor fabrication facility.

17. An apparatus as in claim 1, said lead vehicle further comprising one sensor that prevents said lead vehicle and trailer from collision in said semiconductor fabrication facility.

18. A method for pod transportation within a semiconductor fabrication facility, comprising:
receiving an instruction comprising one of delivery of a pod from a compartment in a trailer attached to a lead vehicle to one of a plurality of stations in said semiconductor fabrication facility and receipt of said pod from one of a plurality of stations in said semiconductor fabrication facility into said compartment of said trailer;
transporting said trailer to said one of a plurality of stations in said semiconductor fabrication facility described in said instruction; and,
causing said trailer to deliver said pod to said one of a plurality of stations in response to receipt of a delivery instruction and receive said pod to said one of a plurality of stations in response to receipt of a receive instruction.

19. A method as in claim 18, said instruction in said receiving step further comprising one of delivery of a pod from a compartment in said lead vehicle to one of a plurality of stations in said semiconductor fabrication facility and receipt of a pod from one of a plurality of stations in said semiconductor fabrication facility into said compartment of said lead vehicle.

20. A method as in claim 19, further comprising:
receiving said pod from one of a plurality of stations in said semiconductor facility into an empty compartment of said lead vehicle in response to receipt of said lead vehicle receive instruction.

21. A method as in claim 20, said causing step occurring simultaneously with said second receiving step.

22. A method as In claim 20, said causing step occurring prior to said second receiving step.

23. A method as in claim 20, said causing step occurring after said second receiving step.

24. A method as in claim 19, further comprising:
delivering said pod from said compartment of said lead vehicle to one of a plurality of stations in said semiconductor facility in response to receipt of said lead vehicle delivery instruction.

25. A method as in claim 24, said causing step occurring simultaneously with said delivering step.

26. A method as in claim 24, said causing step occurring prior to said delivering step.

27. A method as in claim 24, said causing step occurring after said delivering step.
